(19) United States
(12) Patent Application Publication
(10) Pub. No.: US 2025/0130341 A1
(43) Pub. Date: Apr. 24, 2025

(54) METHOD AND APPARATUS FOR IMPROVING DAS SIGNAL-TO-NOISE RATIO BY MEANS OF LOCAL FK TRANSFORM

(71) Applicants: China National Petroleum Corporation, Beijing (CN); BGP Inc., China National Petroleum Corporation, Hebei (CN)

(72) Inventors: Yanpeng LI, Hebei (CN); Junjun WU, Hebei (CN); Jing WANG, Hebei (CN); Yanbin ZHANG, Hebei (CN)

(73) Assignees: China National Petroleum Corporation, Beijing (CN); BGP Inc., China National Petroleum Corporation, Hebei (CN)

(21) Appl. No.: 18/688,189

(22) PCT Filed: Jun. 29, 2022
(86) PCT No.: PCT/CN2022/102502

§ 371 Date: Feb. 29, 2024

(30) Foreign Application Priority Data
Dec. 29, 2021 (CN) 202111631469.1

(51) Int. Cl. G01V 1/36; G01V 1/32

(52) U.S. Cl. CPC G01V 1/362; G01V 1/325; G01V 2210/32; G01V 2210/44

(57) ABSTRACT

A method for improving DAS signal-to-noise ratio by means of local FK transform. The method includes: acquiring seismic wavefield data; segmenting the seismic wavefield data into a plurality of pieces of local data, wherein each piece of local data has the same dimension as the seismic wavefield data; processing each piece of local data by means of the following steps: performing FK transform to obtain an intermediate signal, removing some FK spectrum components from the intermediate signal according to scanning energy which corresponds to the intermediate signal under different apparent slowness, and performing two-dimensional inverse FFT on the intermediate signal, from which some FK spectrum components are removed; and combining all the processed local data, so as to obtain new seismic wavefield data.

### CROSS REFERENCE TO RELATED APPLICATIONS

This application claims priority to Chinese Application No. 202111631469.1, filed on Dec. 29, 2021, entitled “A method and apparatus for improving DAS signal-to-noise ratio by means of local FK transform”, which is specifically and entirely incorporated by reference.

### FIELD OF THE INVENTION

The present disclosure relates to the technical field of optical fiber sensing and seismic data processing, in particular to a method for improving DAS signal-to-noise ratio by means of local FK transform, an apparatus for improving DAS signal-to-noise ratio by means of local FK transform, a device for improving DAS signal-to-noise ratio by means of local FK transform and a corresponding storage medium.

### BACKGROUND OF THE INVENTION

An optical fiber distributed acoustic sensing (DAS) technology is a rapidly developing new technology in recent years, which is being increasingly widely used in borehole seismic exploration. Compared with conventional geophone acquisition, it has significant advantages such as high-density sampling and resistance to high temperature and high pressure. The DAS technology mainly uses Rayleigh backscattering (RBS) generated when laser pulse propagates in optical fiber. When formation around the optical fiber vibrates, RBS will carry information of formation vibration changes. Through continuous observation and phase demodulation of this optical signal, seismic wave information of the formation may be obtained.

DAS is relatively suitable for seismic wave observation in a well. When the optical fiber is laid in a suspended mode in the well, its signal-to-noise ratio is relatively low due to poor coupling with a well wall, which seriously affects the overall effect of receiving a seismic wave. How to effectively improve the signal-to-noise ratio of DAS data has become a difficulty in the application of DAS in seismic exploration. Research indicates that currently, certain application effects in improving the signal-to-noise ratio of the DAS data may be worked generally based on modes such as frequency wavenumber domain filtering or median filtering, but such noise cannot be completely eliminated, or it may harm some effective signals. At present, there is no fidelity processing method that uses local FK transform (frequency wavenumber transform) to improve the signal-to-noise ratio of the DAS data. There are still many shortcomings in existing methods in practical applications, and how to effectively improve the signal-to-noise ratio of seismic data collected by the optical fiber DAS without reducing its fidelity is an urgent need.

### SUMMARY OF THE INVENTION

An objective of an embodiment of the present disclosure is to provide a method and device for improving DAS signal-to-noise ratio by means of local FK transform. Mainly based on the high-density characteristics of borehole seismic data collected by optical fiber DAS, random noise is suppressed adaptively after local FK transform, a linear event is retained, so as to suppress the DAS noise, and improve the signal-to-noise ratio. In practical production applications, the effect of improving the quality of optical fiber DAS seismic data acquisition is obvious, and it is applicable to a denoising processing process of other seismic data.

In order to realize the above objective, a first aspect of the present disclosure provides a method for improving DAS signal-to-noise ratio by means of local FK transform, including: acquiring seismic wavefield data; segmenting the seismic wavefield data into a plurality of pieces of local data, each piece of local data having the same dimension as the seismic wavefield data; processing each piece of local data through the following steps:
obtaining an intermediate signal through FK transform; removing partial FK spectral components in the intermediate signal according to scanning energy corresponding to the intermediate signal under different apparent slowness; performing two-dimensional FFT inverse transform on the intermediate signal with the partial FK spectral components removed; and combining all processed local data to obtain new seismic wavefield data.

Preferably, segmenting the seismic wavefield data into the plurality of pieces of local data includes: setting a segmentation size and a segmentation step length on each dimension respectively according to the dimensions of the seismic wavefield data; and segmenting the seismic wavefield data into the plurality of pieces of local data according to the segmentation step length in the segmentation size.

Preferably, the dimensions include a time dimension and a space dimension; the segmentation size on the time dimension is determined according to the apparent period in the seismic wavefield data; and the segmentation size on the space dimension is determined according to the apparent wavenumber in the seismic wavefield data.

Preferably, removing the partial FK spectral components in the intermediate signal according to the scanning energy corresponding to the intermediate signal under the different apparent slowness includes: presetting a set of apparent slowness and scanning parameters of the apparent slowness; and executing the following operations on each apparent slowness:
acquiring the scanning energy corresponding to the intermediate signal under the current apparent slowness; and removing FK spectral components corresponding to the apparent slowness smaller than an energy threshold.

Preferably, the scanning parameters of the apparent slowness include: an apparent slowness scanning range, intervals between multiple apparent slowness, and a scanning frequency range.

Preferably, combining all the processed local data to obtain the new seismic wavefield data includes: stacking each piece of processed local data according to positions of the local data in the seismic wavefield data; obtaining stacked seismic wavefield data after stacking all the processed local data; and obtaining the new seismic wavefield data according to a stacked value in the stacked seismic wavefield data and the stacking fold corresponding to the stack value.

Preferably, the seismic wavefield data is one of a plurality of pieces of seismic wavefield data in shot gather, and other seismic wavefield data in the shot gather adopts the same processing process and processing parameters as the seismic wavefield data.

A second aspect of the present disclosure further provides an apparatus for improving DAS signal-to-noise ratio by means of local FK transform, including: a data acquiring module, configured to acquire seismic wavefield data; a data segmenting module, configured to segment the seismic wavefield data into a plurality of pieces of local data, each piece of local data having the same dimension as the seismic wavefield data; a data processing module, configured to obtain an intermediate signal through FK transform, remove partial FK spectral components in the intermediate signal according to scanning energy corresponding to the intermediate signal under different apparent slowness, and perform two-dimensional FFT inverse transform on the intermediate signal with the partial FK spectral components removed; and a data combining module, configured to combine all local data processed by the data processing module to obtain new seismic wavefield data.

A third aspect of the present disclosure further provides a device for improving DAS signal-to-noise ratio by means of local FK transform, including a memory, a processor and a computer program stored on the memory and capable of running on the processor, and the processor, when executes the computer program, implements the method for improving the DAS signal-to-noise ratio by means of local FK transform mentioned above.

A fourth aspect of the present disclosure provides a computer readable storage medium, the storage medium stores an instruction, and the instruction, when runs on a computer, enables the computer to execute the method for improving the DAS signal-to-noise ratio by means of local FK transform mentioned above.

A fifth aspect of the present disclosure provides a computer program product, including a computer program, and the computer program, when executed by a processor, implements the method for improving the DAS signal-to-noise ratio by means of local FK transform mentioned above.

The above technical solutions have the following beneficial effects:

The implementation of the present disclosure is a method for suppressing random noise and improving the signal-to-noise ratio of the seismic data collected by the optical fiber DAS. After processing of this implementation, noise of the borehole seismic data collected by the optical fiber DAS may be greatly suppressed and eliminated, significantly improving the quality of data information and providing guarantee for subsequent seismic data processing and interpretation. The implementation provided by the present disclosure is further applicable to a denoising processing process of other seismic data.

Other features and advantages of embodiments of the present disclosure will be described in detail in the subsequent detailed description of the embodiments.

### BRIEF DESCRIPTION OF DRAWINGS

Accompanying drawings are used to provide further understanding of embodiments of the present disclosure, form a part of the specification, and are used to explain the embodiments of the present disclosure together with the following detailed description of the embodiments, but do not constitute a limitation on the embodiments of the present disclosure. In the accompanying drawings:

FIG. 1 schematically shows a schematic diagram of steps of a method for improving DAS signal-to-noise ratio by means of local FK transform according to an embodiment of the present application.

FIG. 2 schematically shows a schematic diagram of seismic wavefield data according to an embodiment of the present application.

FIG. 3 schematically shows a schematic diagram of a frequency spectrum after FK transform according to an embodiment of the present application.

FIG. 4 schematically shows a schematic diagram of results of scanning energy under different apparent slowness according to an embodiment of the present application.

FIG. 5 schematically shows a schematic diagram of new seismic wavefield data according to an embodiment of the present application.

FIG. 6 schematically shows a schematic structural diagram of an apparatus for improving DAS signal-to-noise ratio by means of local FK transform according to an embodiment of the present application.

### DETAILED DESCRIPTION OF THE EMBODIMENTS

The specific implementation of embodiments of the present disclosure is illustrated in detail below in conjunction with the accompanying drawings. It should be understood that the specific implementation described herein is only used to illustrate and explain the embodiments of the present disclosure and is not used to limit the embodiments of the present disclosure.

The acquisition, storage, use, processing and the like of data in the technical solutions of the present application comply with relevant provisions of national laws and regulations.

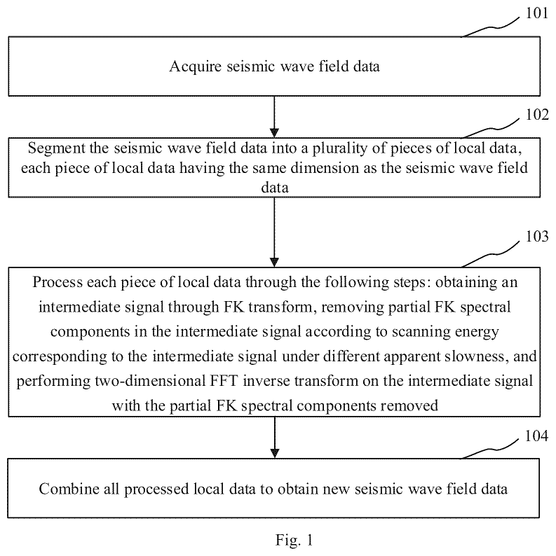

FIG. 1 schematically shows a schematic diagram of steps of a method for improving DAS signal-to-noise ratio by means of local FK transform according to an embodiment of the present application. As shown in FIG. 1, in one embodiment of the present application, the method for improving the DAS signal-to-noise ratio by means of local FK transform is provided, including:
101, acquire seismic wavefield data;
102, segment the seismic wavefield data into a plurality of pieces of local data, each piece of local data having the same dimension as the seismic wavefield data;
103, process each piece of local data through the following steps: obtaining an intermediate signal through FK transform, removing partial FK spectral components in the intermediate signal according to scanning energy corresponding to the intermediate signal under different apparent slowness, and performing two-dimensional FFT inverse transform on the intermediate signal with the partial FK spectral components removed; and
104, combine all processed local data to obtain new seismic wavefield data.

In this implementation, the seismic wavefield data may be acquired from an optical fiber distributed acoustic sensing (DAS) acquisition instrument, the acquired seismic wavefield data is segmented into the plurality of pieces of local data, and each piece of local data is a part of the seismic wavefield data. FK transform is performed on each piece of local data, energy is scanned by adopting apparent slowness, FK spectral components are removed based on scanning results, so that energy performance of the noise under different apparent slowness is used to remove the noise, and the signal-to-noise ratio is improved. Finally, the intermediate signal with the partial FK spectral components removed in a frequency domain is inversely transformed and combined into the new seismic wavefield data, and these two steps are reverse processes of segmentation and FK transform in the previous step, so as to improve the signal-to-noise ratio of the original seismic wavefield data.

Through the above mode, the noise of the borehole seismic data collected by the optical fiber DAS can be effectively suppressed, and guarantee is provided for subsequent seismic data processing and interpretation.

In some implementations provided by the present disclosure, segmenting the seismic wavefield data into the plurality of pieces of local data includes: a segmentation size and a segmentation step length are set on each dimension respectively according to the dimensions of the seismic wavefield data; and the seismic wavefield data is segmented into the plurality of pieces of local data according to the segmentation step length and the segmentation size. The segmentation mode in this implementation may adopt a sliding window mode for segmentation. For example, the segmentation sizes are set on the dimensions to be L1, L2 . . . , and Ln respectively, n is the number of dimensions, and correspondingly, sliding step lengths are Step₁, Step₂, . . . , and Stepₙ respectively. Through the above segmentation mode, the segmented local data is obtained, each piece of local data has the same dimension as the seismic wavefield data, but it is only a subset of the original seismic wavefield data.

In some implementations provided by the present disclosure, the dimensions include a time dimension and a space dimension; the segmentation size on the time dimension is determined according to the apparent period in the seismic wavefield data; and the segmentation size on the space dimension is determined according to the apparent wavenumber in the seismic wavefield data (the apparent wavenumber is the reciprocal of the apparent wavelength). The commonly selected dimensions of the seismic wavefield data include the time dimension and the space dimension, and the space dimension may be in a depth direction. The corresponding segmentation size L1 on the time dimension may be determined according to the apparent period of seismic wavefield, which is generally 2-5 times the apparent period. The corresponding segmentation size L2 on the space dimension may be determined according to the apparent wavenumber K, which is generally 2-5 times of 1/K (the apparent wavelength), namely 2-5/K. For example, the segmentation sizes corresponding to the time dimension and the space dimension may be taken as L1=100 ms and L2=100 meters, and correspondingly, the segmentation step lengths Step₁=50 ms and Step₂=10 meters.

In some optional implementations provided by the present disclosure, removing the partial FK spectral components in the intermediate signal according to the scanning energy corresponding to the intermediate signal under different apparent slowness includes: a set of apparent slowness and scanning parameters of the apparent slowness are preset; for example, here the apparent slowness S is equal to K/F, 100 pieces of apparent slowness are scanned, the apparent slowness scanning ranges from −0.002 s/m to 0.002 s/m with an interval of 0.00004 s/m, and a scanning frequency range is a seismic wave dominant frequency band ranging from 10 Hz to 50 Hz. And the following operations are executed on each piece of apparent slowness: acquiring the scanning energy corresponding to the intermediate signal under the current apparent slowness, and removing FK spectral components corresponding to the apparent slowness smaller than an energy threshold. Taking the use of a sliding window for segmentation as an example, FK transform is performed on local data in the sliding window, energy is scanned according to different apparent slowness, and a threshold A is set. Here, a value of the threshold A may range from Amax×10% to Amax×50%, and Amax here is maximum scanning energy in local FK domain. The FK spectral components corresponding to the apparent slowness greater than the threshold are retained, and the FK spectral components corresponding to the apparent slowness smaller than the threshold are removed, namely set to be 0. Through the above implementation, the FK spectral components with low energy may be removed in an FK domain, so that a purpose of suppressing random noise is realized.

In some optional implementations provided by the present disclosure, combining all the processed local data to obtain the new seismic wavefield data includes: each piece of processed local data is stacked according to positions of the local data in the seismic wavefield data; stacked seismic wavefield data is obtained after stacking all the processed local data; and the new seismic wavefield data is obtained according to a stacked value in the stacked seismic wavefield data and the stacking fold corresponding to the stacked value. Specifically, the processed local data obtained in the previous implementation is stacked according to original time and space positions, and stacked results are written into output records. The stack mode includes sliding and stacking along the time and space dimensions with Step₁=50 ms and Step₂=10 meters as the step lengths, the stacking fold of each sample point are recorded, a stacked value of each sample point of final stack records is divided by the stacking fold to obtain the final seismic wavefield data after suppressing noise, namely, the new seismic wavefield data, and it is taken as the output records.

In some optional implementations provided by the present disclosure, the seismic wavefield data is one of a plurality of pieces of seismic wavefield data in shot gather, and other seismic wavefield data in the shot gather adopts the same processing process and processing parameters as the seismic wavefield data. The above steps are repeated for all to-be-processed shot gathers, so as to complete the processing of improving the signal-to-noise ratio of all seismic wavefield data in the shot gathers. The seismic wavefield data after above processing is provided for subsequent processing modules such as deconvolution, wavefield separation, and migration imaging, to complete all processing, and it is provided for seismic geological interpretation and the like.

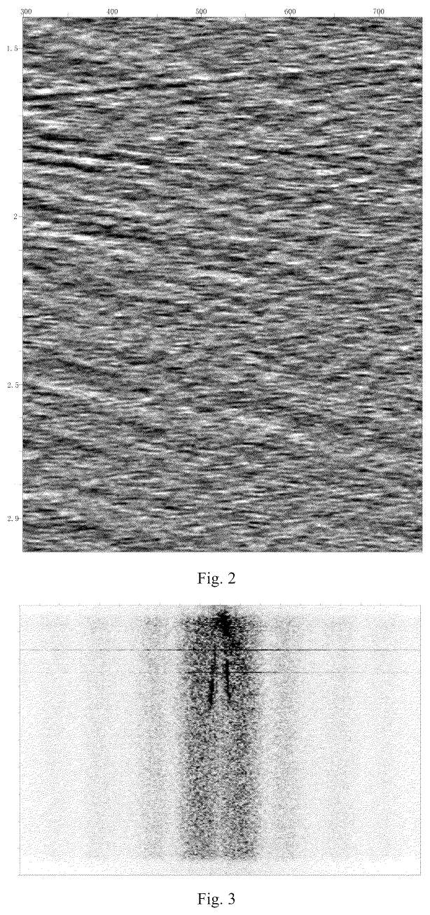

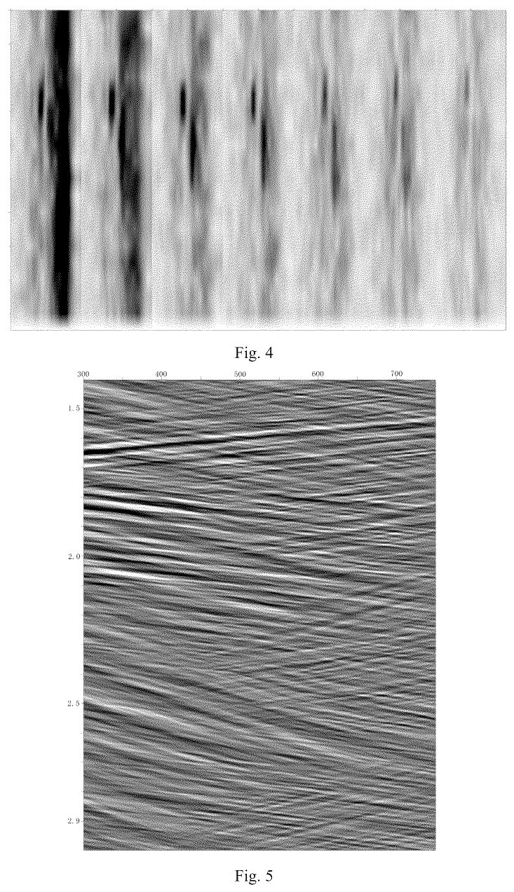

In order to verify the effect of the implementation of the present disclosure, actual borehole seismic data collected by optical fiber DAS for a certain oil well in BoHai Bay of China are processed as follows. First, the optical fiber is suspended in a wellbore, vibroseis excitation is performed through the ground to obtain seismic wavefield data collected by the optical fiber DAS, the seismic wavefield data is provided with a sliding window in a time direction of 100 milliseconds and a space direction of 100 meters for local FK transform, energy scanning is performed in an apparent slowness direction in a transform domain, the threshold is set according to the energy distribution, partial spectral component is selected, and the signal-to-noise ratio of the seismic data collected by the optical fiber DAS is greatly improved after reverse transform. The specific steps are as follows:
1) an optical fiber distributed acoustic sensing (DAS) acquisition instrument is used, optical cables are suspended in a well or laid outside a casing pipe for receiving, the artificial vibroseis is excited on the ground to collect DAS seismic wavefield data of a whole well section, as shown in FIG. 2. FIG. 2 schematically shows a schematic diagram of seismic wavefield data according to an embodiment of the present application.
2) a sliding window is selected for the collected data obtained in step 1), sizes of the sliding window in time and depth directions are L1=100 ms and L2=100 meters respectively, and sliding step lengths are Step₁=50 ms and Step₂=10 meters respectively.
3) FK transform is performed on data in the sliding window, transformed results are as shown in FIG. 3, and FIG. 3 schematically shows a schematic diagram of a frequency wavenumber spectrum after FK transform according to an embodiment of the present application. The energy is scanned according to different apparent slowness, scanned results are as shown in FIG. 4, and FIG. 4 schematically shows a schematic diagram of results of scanning energy under different apparent slowness according to an embodiment of the present application. A threshold A=Amax*50% is set, that is, it is 50% of the maximum scanning energy, the FK spectral components corresponding to the apparent slowness greater than the threshold are retained, and the FK spectral components corresponding to the apparent slowness smaller than the threshold are removed, namely set to be 0. Here, the apparent slowness S is equal to K/F, the apparent slowness scanning ranges from −0.002 s/m to 0.002 s/m, 100 pieces of apparent slowness are scanned with an interval of 0.00004 s/m, and a scanning frequency range is a seismic wave dominant frequency band ranging from 10 Hz to 50 Hz.
4) two-dimensional FFT inverse transform is performed by using FK domain data obtained in step 3) to obtain records of the current sliding window after removing noise.
5) the seismic data after suppressing noise obtained in step 4) is stacked on output records according to original time and space positions, sliding is performed along the time and space dimensions with Step₁=50 ms and Step₂=10 meters as the step lengths, steps 3) and 4) are repeated, the stacking fold of each sample point is recorded, each sample point of final stack records is divided by the stacking fold to obtain the final output records after suppressing noise, as shown in FIG. 5, and FIG. 5 schematically shows a schematic diagram of new seismic wavefield data according to an embodiment of the present application.
6) The steps 3), 4) and 5) are repeated for all to-be-processed shot gathers, so as to complete the processing of improving the signal-to-noise ratio of all seismic wavefield data.
7) The data after above processing is provided for subsequent processing modules such as deconvolution, wavefield separation, and migration imaging, to complete all processing, and it is provided for seismic geological interpretation and the like.

Through the above implementation, the noise of the borehole seismic data collected by the optical fiber DAS may be suppressed and eliminated to a large extent, thereby improving the quality of data information and providing guarantee for subsequent seismic data processing and interpretation.

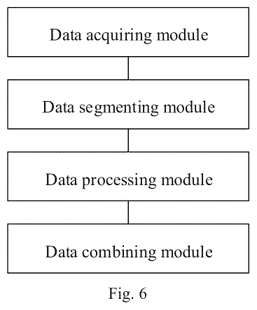

Based on the same inventive concept, an implementation of the present disclosure further provides an apparatus for improving DAS signal-to-noise ratio by means of local FK transform. FIG. 6 schematically shows a schematic structural diagram of an apparatus for improving DAS signal-to-noise ratio by means of local FK transform according to an embodiment of the present application. As shown in FIG. 6, the apparatus includes: a data acquiring module, configured to acquire seismic wavefield data; a data segmenting module, configured to segment the seismic wavefield data into a plurality of pieces of local data, each piece of local data having the same dimension as the seismic wavefield data; a data processing module, configured to obtain an intermediate signal through FK transform, remove partial FK spectral components in the intermediate signal according to scanning energy corresponding to the intermediate signal under different apparent slowness, and perform two-dimensional FFT inverse transform on the intermediate signal with partial FK spectral components removed; and a data combining module, configured to combine all local data processed by the data processing module to obtain new seismic wavefield data.

In some optional implementations, segmenting the seismic wavefield data into the plurality of pieces of local data includes: a segmentation size and a segmentation step length are set on each dimension respectively according to the dimensions of the seismic wavefield data; and the seismic wavefield data is segmented into the plurality of pieces of local data according to the segmentation step length in the segmentation size.

In some optional implementations, the dimensions include a time dimension and a space dimension; the segmentation size on the time dimension is determined according to the apparent period in the seismic wavefield data; and the segmentation size on the space dimension is determined according to the apparent wavenumber in the seismic wavefield data.

In some optional implementations, removing the partial FK spectral components in the intermediate signal according to the scanning energy corresponding to the intermediate signal under different apparent slowness includes: a set of apparent slowness and scanning parameters are preset; and the following operations are executed on each piece of apparent slowness in the plurality of pieces of apparent slowness: acquiring the scanning energy corresponding to the intermediate signal under the current apparent slowness, and removing FK spectral components corresponding to the apparent slowness smaller than an energy threshold.

In some optional implementations, the scanning parameters of the apparent slowness include: an apparent slowness scanning range, intervals between the plurality of pieces of apparent slowness, and a scanning frequency range.

In some optional implementations, combining all the processed local data to obtain the new seismic wavefield data includes: each piece of processed local data is stacked according to positions of the local data in the seismic wavefield data; stacked seismic wavefield data is obtained after stacking all the processed local data; and the new seismic wavefield data is obtained according to a stacked value in the stacked seismic wavefield data and the stacking fold corresponding to the stacked value.

In some optional implementations, the seismic wavefield data is one of a plurality of pieces of seismic wavefield data in shot gather, and other seismic wavefield data in the shot gather adopts the same processing process and processing parameters as the seismic wavefield data.

Those skilled in the art may understand that, the structure shown in FIG. 6 is merely a block diagram of a partial structure related to a solution in the present application, and does not constitute a limitation to a computer device to which the solution in the present application is applied. Specifically, the computer device may include more components or fewer components than those shown in the figure, or may combine some components, or may have a different component deployment.

The specific limitations of each implementation step in the apparatus for improving the DAS signal-to-noise ratio by means of local FK transform mentioned above may refer to the limitations on the method for improving the DAS signal-to-noise ratio by means of local FK transform mentioned above, which will not be repeated here. Its beneficial effects may also be applicably inferred according to the method for improving the DAS signal-to-noise ratio by means of local FK transform mentioned above.

An embodiment of the present application provides a device, including a processor, a memory and a program stored on the memory and capable of running on the processor, and the processor, when executes the program, implements steps of the method for improving the DAS signal-to-noise ratio by means of local FK transform.

The present application further provides a computer program product, and the computer program product, when executed on a data processing device, is suitable for executing a program that initializes steps of the method for improving the DAS signal-to-noise ratio by means of local FK transform.

Those skilled in the art will appreciate that the embodiments of the present application may be provided as methods, systems, or computer program products. Therefore, the present application may take the form of a full hardware embodiment, a full software embodiment, or an embodiment combining software and hardware. Besides, the present application may adopt the form of a computer program product implemented on one or more computer available storage media (including but not limited to a disk memory, a CD-ROM, an optical memory and the like) containing computer available program codes.

The present application is described with reference to the flow diagram and/or block diagram of the method, device (system), and computer program product according to the embodiments of the present application. It should be understood that each flow and/or block in the flow chart and/or block diagram and the combination of flows and/or blocks in the flow chart and/or block diagram may be implemented by computer program instructions. These computer program instructions may be provided to processors of a general-purpose computer, a special-purpose computer, an embedded processor or other programmable data processing devices to generate a machine, so that instructions executed by processors of a computer or other programmable data processing devices generate an apparatus for implementing functions specified in one or more flows of the flow chart and/or one or more blocks of the block diagram.

These computer program instructions may also be stored in a computer-readable memory capable of guiding a computer or other programmable data processing devices to work in a specific manner, so that instructions stored in the computer-readable memory generate a manufacturing product including an instruction apparatus, and the instruction apparatus implements the functions specified in one or more flows of the flow chart and/or one or more blocks of the block diagram.

These computer program instructions may also be loaded on the computer or other programmable data processing devices, so that a series of operation steps are executed on the computer or other programmable devices to produce computer-implemented processing, and thus, the instructions executed on the computer or other programmable devices provide steps for implementing the functions specified in one or more flows of the flow chart and/or one or more blocks of the block diagram.

In a typical configuration, a computing device includes one or more central processing units (CPUs), an input/output interface, a network interface, and a memory.

A memory may include a non-permanent memory, a random-access memory (RAM) and/or a non-volatile memory in a computer readable medium, such as a read-only memory (ROM) or a flash RAM. The memory is an example of the computer readable medium.

The computer readable medium includes permanent and non permanent, movable and non movable media, and information storage may be achieved by any method or technology. Information may be a computer readable instruction, a data structure, a program module, or other data. Examples of the computer storage medium include, but are not limited to, a phase-change random access memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a read-only optical disc read-only memory (CD-ROM), a digital versatile disc (DVD) or other optical storage magnetic cassette tapes, magnetic disk storage or other magnetic storage devices, or any other non transmission medium, which may be used to store information that may be accessed by the computing device. According to the definition in this article, the computer readable medium does not include transitory computer readable media, such as modulated data signals and carriers.

It should also be noted that terms “including”, “containing”, or any other variation thereof are intended to cover non exclusive inclusion, so that a process, method, commodity, or device that includes a series of elements not only includes those elements, but also other elements that are not explicitly listed, or also include elements inherent in such a process, method, commodity, or device. Without further restrictions, the elements defined by the statement “including one . . . ” do not exclude that there are other identical elements in the process, method, commodity or device including the elements.

The above are only embodiments of the present application and are not intended to limit the present application. For those skilled in the art, the present application may have various modifications and changes. Any modifications, equivalent substitutions, improvements, etc. made within the spirit and principles of the present application shall be included within the scope of the claims of the present application.

1. A method for improving DAS signal-to-noise ratio by means of local FK transform, comprising:
acquiring seismic wavefield data from a DAS acquisition instrument;
segmenting the seismic wavefield data into a plurality of pieces of local data, each piece of local data having the same dimension as the seismic wavefield data;
processing each piece of local data through the following steps: obtaining an intermediate signal through FK transform, removing partial FK spectral components in the intermediate signal according to scanning energy corresponding to the intermediate signal under different apparent slowness, and performing two-dimensional FFT inverse transform on the intermediate signal with the partial FK spectral components removed; and
combining all processed local data to obtain new seismic wavefield data.

2. The method according to claim 1, wherein the segmenting the seismic wavefield data into the plurality of pieces of local data, comprises:
setting a segmentation size and a segmentation step length on each dimension respectively according to dimensions of the seismic wavefield data; and
segmenting the seismic wavefield data into the plurality of pieces of local data according to the segmentation step length and the segmentation size.

3. The method according to claim 2, wherein the dimensions of the seismic wavefield data comprise a time dimension and a space dimension;
the segmentation size on the time dimension is determined according to an apparent period in the seismic wavefield data; and
the segmentation size on the space dimension is determined according to an apparent wavenumber in the seismic wavefield data.

4. The method according to claim 1, wherein removing the partial FK spectral components in the intermediate signal according to the scanning energy corresponding to the intermediate signal under the different apparent slowness comprises:
presetting a set of apparent slowness and scanning parameters; and
executing the following operations on each apparent slowness: acquiring the scanning energy corresponding to the intermediate signal under the current apparent slowness, and removing FK spectral components corresponding to the apparent slowness smaller than an energy threshold.

5. The method according to claim 4, wherein the scanning parameters of the apparent slowness comprise: an apparent slowness scanning range, intervals between multiple apparent slowness, and a scanning frequency range.

6. The method according to claim 1, wherein combining all the processed local data to obtain the new seismic wavefield data, comprises:
stacking each piece of processed local data according to positions of the local data in the seismic wavefield data;
obtaining stacked seismic wavefield data after stacking all the processed local data; and
obtaining the new seismic wavefield data according to a stacked value in the stacked seismic wavefield data and the stacking fold corresponding to the stacked value.

7. The method according to claim 1, wherein the seismic wavefield data is one of a plurality of pieces of seismic wavefield data in shot gather, and other seismic wavefield data in the shot gather adopts the same processing process and processing parameters as the seismic wavefield data.

8.-10. (canceled)

11. A device for improving DAS signal-to-noise ratio by means of local FK transform, comprising: a memory, a processor and a computer program stored on the memory and capable of running on the processor, wherein the processor, when executes the computer program, implements the following steps;
acquiring seismic wavefield data from a DAS acquisition instrument;
segmenting the seismic wavefield data into a plurality of pieces of local data, each piece of local data having the same dimension as the seismic wavefield data;
processing each piece of local data through the following steps: obtaining an intermediate signal through FK transform, removing partial FK spectral components in the intermediate signal according to scanning energy corresponding to the intermediate signal under different apparent slowness, and performing two-dimensional FFT inverse transform on the intermediate signal with the partial FK spectral components removed; and
combining all processed local data to obtain new seismic wavefield data.

12. The device according to claim 11, wherein the segmenting the seismic wavefield data into the plurality of pieces of local data, comprises:
setting a segmentation size and a segmentation step length on each dimension respectively according to dimensions of the seismic wavefield data; and
segmenting the seismic wavefield data into the plurality of pieces of local data according to the segmentation step length and the segmentation size;
wherein, the dimensions of the seismic wavefield data comprise a time dimension and a space dimension, the segmentation size on the time dimension is determined according to an apparent period in the seismic wavefield data, and the segmentation size on the space dimension is determined according to an apparent wavelength in the seismic wavefield data.

13. The device according to claim 11, wherein removing the partial FK spectral components in the intermediate signal according to the scanning energy corresponding to the intermediate signal under the different apparent slowness comprises:
presetting a set of apparent slowness and scanning parameters; and
executing the following operations on each apparent slowness: acquiring the scanning energy corresponding to the intermediate signal under the current apparent slowness, and removing FK spectral components corresponding to the apparent slowness smaller than an energy threshold;
wherein, the scanning parameters of the apparent slowness comprise: an apparent slowness scanning range, intervals between multiple apparent slowness, and a scanning frequency range.

14. The device according to claim 11, wherein combining all the processed local data to obtain the new seismic wavefield data, comprises:
stacking each piece of processed local data according to positions of the local data in the seismic wavefield data;
obtaining stacked seismic wavefield data after stacking all the processed local data; and
obtaining the new seismic wavefield data according to a stacked value in the stacked seismic wavefield data and the stacking fold corresponding to the stacked value.

15. The device according to claim 11, wherein the seismic wavefield data is one of a plurality of pieces of seismic wavefield data in shot gather, and other seismic wavefield data in the shot gather adopts the same processing process and processing parameters as the seismic wavefield data.

16. A non-transitory computer readable storage medium, wherein the storage medium stores an instruction, and the instruction, when runs on a computer, enables the computer to execute the following steps:
acquiring seismic wavefield data from a DAS acquisition instrument;
segmenting the seismic wavefield data into a plurality of pieces of local data, each piece of local data having the same dimension as the seismic wavefield data;
processing each piece of local data through the following steps: obtaining an intermediate signal through FK transform, removing partial FK spectral components in the intermediate signal according to scanning energy corresponding to the intermediate signal under different apparent slowness, and performing two-dimensional FFT inverse transform on the intermediate signal with the partial FK spectral components removed; and
combining all processed local data to obtain new seismic wavefield data.

17. The non-transitory computer readable storage medium according to claim 16, wherein segmenting the seismic wavefield data into the plurality of pieces of local data, comprises:
setting a segmentation size and a segmentation step length on each dimension respectively according to the dimensions of the seismic wavefield data; and
segmenting the seismic wavefield data into the plurality of pieces of local data according to the segmentation step length in the segmentation size;
wherein, the dimensions comprise a time dimension and a space dimension, the segmentation size on the time dimension is determined according to the apparent period in the seismic wavefield data, and the segmentation size on the space dimension is determined according to the apparent wavelength in the seismic wavefield data.

18. The non-transitory computer readable storage medium according to claim 16, wherein removing the partial FK spectral components in the intermediate signal according to the scanning energy corresponding to the intermediate signal under the different apparent slowness comprises:
presetting a set of apparent slowness and scanning parameters; and
executing the following operations on each apparent slowness: acquiring the scanning energy corresponding to the intermediate signal under the current apparent slowness, and removing FK spectral components corresponding to the apparent slowness smaller than an energy threshold;
wherein, the scanning parameters of the apparent slowness comprise: an apparent slowness scanning range, intervals between multiple apparent slowness, and a scanning frequency range.

19. The non-transitory computer readable storage medium according to claim 16, wherein combining all the processed local data to obtain the new seismic wavefield data, comprises:
stacking each piece of processed local data according to positions of the local data in the seismic wavefield data;
obtaining stacked seismic wavefield data after stacking all the processed local data; and
obtaining the new seismic wavefield data according to a stacked value in the stacked seismic wavefield data and the stacking fold corresponding to the stacked value.

20. The non-transitory computer readable storage medium according to claim 16, wherein the seismic wavefield data is one of a plurality of pieces of seismic wavefield data in shot gather, and other seismic wavefield data in the shot gather adopts the same processing process and processing parameters as the seismic wavefield data.
